(19) United States
(12) Patent Application Publication
(10) Pub. No.: US 2017/0130494 A1
(43) Pub. Date: May 11, 2017

(54) LATCH OPERATING MECHANISM FOR CABIN DOOR

(71) Applicant: CATERPILLAR INC., Peoria, IL (US)

(72) Inventors: Matthew R. Schwarzendruber, Peoria, IL (US); Jason Stibs, Marquette Heights, IL (US); James D. Neirynck, Neponset, IL (US)

(73) Assignee: CATERPILLAR INC., Peoria, IL (US)

(21) Appl. No.: 14/936,946

(22) Filed: Nov. 10, 2015

(51) Int. Cl. E05C 1/10; B62D 33/06; E05C 9/20; E05C 9/22; E05C 9/00; E05C 9/02

(52) U.S. Cl. CPC E05C 1/10; E05C 9/006; E05C 9/028; E05C 9/20; E05C 9/22; B62D 33/0617

(57) ABSTRACT

A latch operating mechanism for a cabin door is provided. The latch operating mechanism includes a lever member, a tubular housing member and an elongated member. The tubular housing member is coupled to the lever member and has an axially extending cavity. The tubular housing member is adapted to be coupled to the cabin door. The tubular housing member has an opening formed therein through which the lever member is disposed. The lever member is hingedly coupled to the tubular housing member along a hinge axis and is extended outwardly from the cavity of the tubular housing member. The elongated member is positioned substantially within the axially extending cavity of the tubular housing member. The elongated member is coupled to the lever member and a latch of the cabin door. The elongated member is axially movable between an extended position and a retracted position, and being biased in its extended position.

### TECHNICAL FIELD

The present disclosure relates generally to cabin doors of machines, and more particularly to a latch operating mechanism for a cabin door of a machine.

### BACKGROUND

Cabins are provided on machines such as hydraulic excavators, fork lifts, loaders, shovels, feller bunchers, and other type of construction machines, to fully enclose an operator occupying an operator's seat. The cabins include cabin doors to enable ingress and egress to and from the cabins. The cabin doors are hingedly coupled to a frame of the cabin. Further, the cabin doors are provided with a latch for selectively locking and unlocking a hinged movement of the cabin doors with respect to the frame of the cabin. The latch is positioned within the cabin such that the latch is accessible to the operator of the machine.

Conventionally, the operator of the machine, in order to unlock the latch, may have to hold a tube coupled to the latch, and thereafter squeeze an actuating link. This conventional operation of unlocking the latch may require the operator to apply a considerable amount of effort. Therefore such operation for unlocking the latch may be non-ergonomic for the operators.

U.S. Pat. No. 7,677,648 discloses a work vehicle having a frame structurally carrying a cab structure and a door pivotably coupled to the cab structure. The door includes a first handle and a second handle secured to the door disposed for facilitating door closure against the cab structure from interior of the cab structure. A door opening device is pivotably coupled to the cab structure and to the door in close proximity to the first handle, or is pivotably coupled to the cab structure and to the first handle. Upon application of a door closure force to the first handle, torsion forces applied to the door by the door closure force and the device, as calculated at the device pivotable connection opposite the cab structure, is reduced when compared to application of a door closure force to the second handle.

### SUMMARY OF THE DISCLOSURE

In one aspect of the present disclosure, a latch operating mechanism for a cabin door is provided. The latch operating mechanism includes a lever member, a tubular housing member and an elongated member. The tubular housing member is coupled to the lever member and has an axially extending cavity. The tubular housing member is adapted to be coupled to the cabin door. The tubular housing member has an opening formed therein through which the lever member is disposed. The lever member is hingedly coupled to the tubular housing member along a hinge axis and is extended outwardly from the cavity of the tubular housing member. The elongated member is positioned substantially within the axially extending cavity of the tubular housing member. The elongated member is coupled to the lever member and a latch of the cabin door. The elongated member is axially movable between an extended position and a retracted position, and being biased in its extended position.

In another aspect of the present disclosure, a method of operating a latch of a cabin door is provided. The method includes applying a force on a lever member to hingedly move the lever member with respect to a tubular housing member. The method further includes moving an elongated member in a first direction with respect to the tubular housing member by a leveraging force applied on the lever member. Further, the method includes actuating an actuating spring of the latch of the cabin door, by the movement of the elongated member in the first direction with respect to the tubular housing member, to unlock the latch of the cabin door.

In yet another aspect of the present disclosure, a machine is disclosed. The cabin includes a frame, a plurality of panel members coupled to the frame, a cabin door coupled to the frame to enable egress and ingress in the cab, a latch mounted on the cabin door, and a latch operating mechanism. The latch operating mechanism includes a lever member, a tubular housing member and an elongated member. The tubular housing member is coupled to the lever member and has an axially extending cavity. The tubular housing member is adapted to be coupled to the cabin door. The tubular housing member has an opening formed therein through which the lever member is disposed. The lever member is hingedly coupled to the tubular housing member along a hinge axis and is extended outwardly from the cavity of the tubular housing member. The elongated member is positioned substantially within the axially extending cavity of the tubular housing member. The elongated member is coupled to the lever member and a latch of the cabin door. The elongated member is axially movable between an extended position and a retracted position, and being biased in its extended position.

Other features and aspects of this disclosure will be apparent from the following description and the accompanying drawings.

### BRIEF DESCRIPTION OF THE DRAWINGS

FIG. 1 is a schematic perspective view of an exemplary cabin of a machine, according to an embodiment of the present disclosure;

FIG. 2 is a side view of an cabin door of the machine, according to an embodiment of the present disclosure;

FIG. 3 is a perspective view of a latch operating mechanism for a cabin door, according to an embodiment of the present disclosure;

FIG. 4 is a sectional view of the latch operating mechanism taken along section line C-C′ of FIG. 3, according to an embodiment of the present disclosure; and

FIG. 5 is a flowchart of a method of operating a latch of the cabin door, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

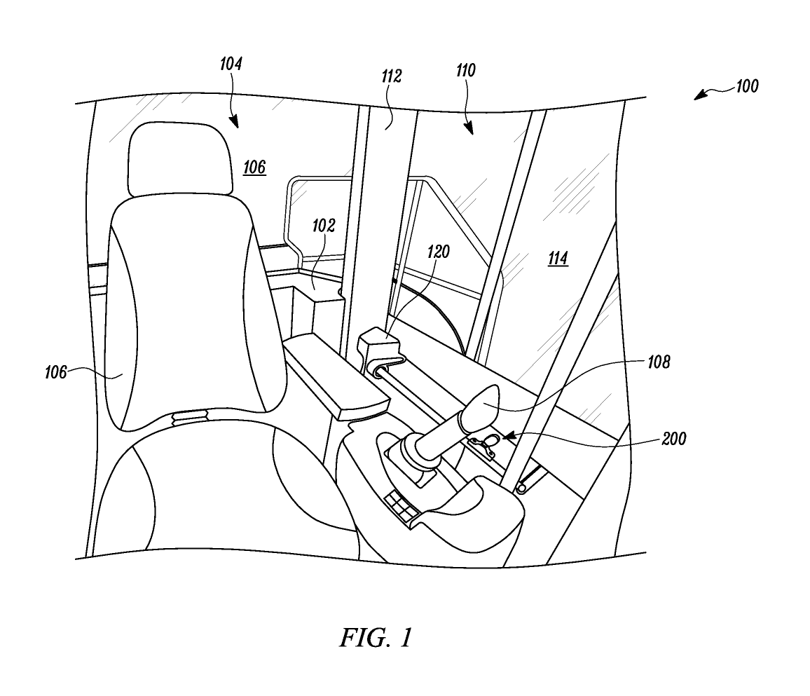

FIG. 1 illustrates schematic perspective view of an exemplary cabin 100 of a machine such as a wheel loader, a track-type tractor, a hydraulic excavator, a haul truck, a large mining truck, an off-highway truck, an on-highway truck, and other types of industrial or commercial vehicles. The cabin 100 is mounted on top of the machine. The cabin 100 includes a frame 102 that defines the shape of the cabin 100. The frame 102 may be provided with Roll Over Protection System (ROPS). As would be known to those skilled in the art, the purpose of the ROPS is to provide a structure that may prevent the cabin 100 from being crushed in an event of a rollover.

In particular, a plurality of panel members 104, such as side panel members, and top panel members, may be coupled to the frame 102 to form the cabin 100. The each of the panel members 104 may have a planar surface. Moreover, one or more of the panel members 104 may be formed from a transparent material (for e.g., glass, clear plastic, and the like) to allow a view of the environment to the operator inside the cabin 100. However, in other embodiments, the panel members 104 may be formed from translucent or opaque materials depending upon specific requirements of an application. For example, the panel members 104 may be formed from a blank sheet metal that is configured to offer opacity and restrict of a view of the environment in which the machine is operating. Therefore, a type and nature/opacity of the panel members 104 is merely exemplary in nature and hence, non-limiting of this disclosure. Any type and/or nature/opacity of the panel members 104 may be implemented without deviating from the spirit of the present disclosure.

Further, at least one operator's seat 106 and various control members, such as one or more levers 108, pedals, and the like, are also housed within the cabin 100. The one or more levers 108, pedals, and the like are positioned proximate to the operator's seat 106 such that the one or more levers 108, pedals, and the like may be accessible to an operator occupying the operator's seat 106.

The cabin 100 further includes at least one cabin door 110. The cabin door 110 may be coupled with the frame 102. Further, the cabin door 110 may be suitably shaped and sized to facilitate easy entry and exit of the operator into and from the cabin 100, when the cabin door 110 is open. The cabin door 110 includes a door frame 112 and a window portion 114. The door frame 112 rigidly supports the window portion 114. The window portion 114 may have a planar surface and may be pivotably coupled to the door frame 112 for opening movement independent of the door frame 112. Moreover, the window portion 114 may be beneficially formed from a transparent material (for e.g., glass, clear plastic, and the like) to allow a view of the environment to the operator. However, in other embodiments, the window portion 114 may be formed from translucent or opaque materials depending upon specific requirements of an application.

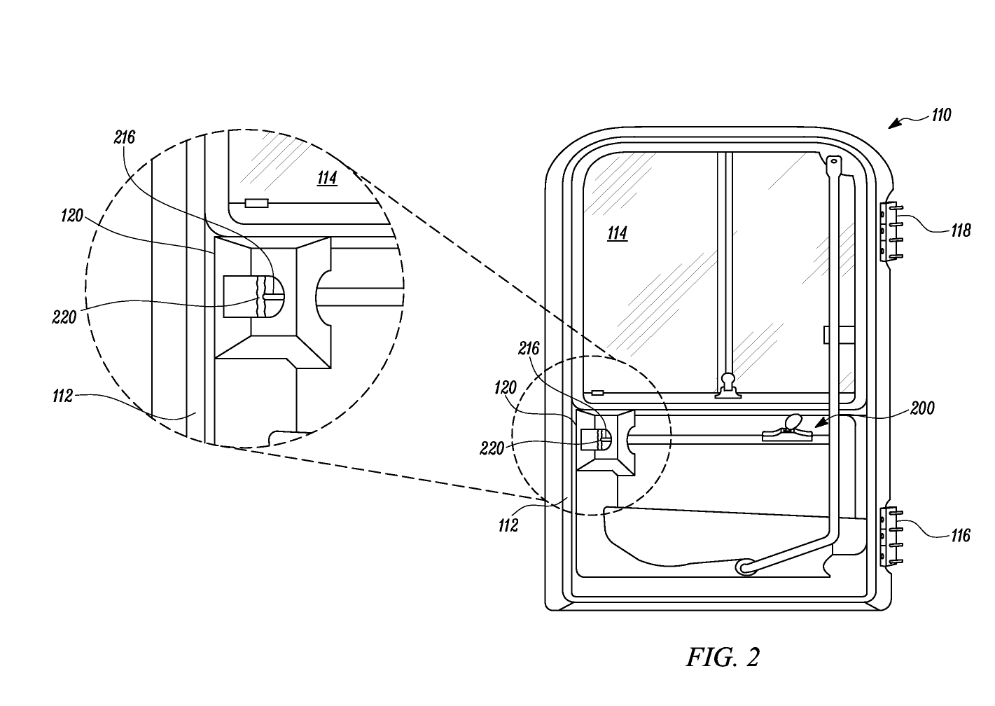

Referring now to FIG. 2, wherein side view of the cabin door 110 of the cabin 100 is illustrated. The cabin door 110 may be coupled with the frame 102 through suitable coupling, such as through a set of hinges 116, 118. Such coupling allows the cabin door 110 to hingedly move with respect to the frame 102, to open and close.

The cabin door 110 further includes a latch 120. The latch 120 may be provided on the door frame 112 of the cabin door 110. The latch 120 may be in engagement with both the frame 102 and the cabin door 110 (shown in FIG. 1). In a latched state, the latch 120 may be locked with the frame 102, thereby resisting movement of the cabin door 110 with respect to the frame 102. In other words, the latch 120, in its latched state, may inhibit the opening of the cabin door 110. Likewise, in an unlatched state, the latch 120 may be disengaged from the frame 102, and thereby allowing relative movement between the cabin door 110 and the frame 102. In other words, the latch 120, in its unlatched state, may allow the opening of the cabin door 110, such that the operator may enter or exit the cabin 100.

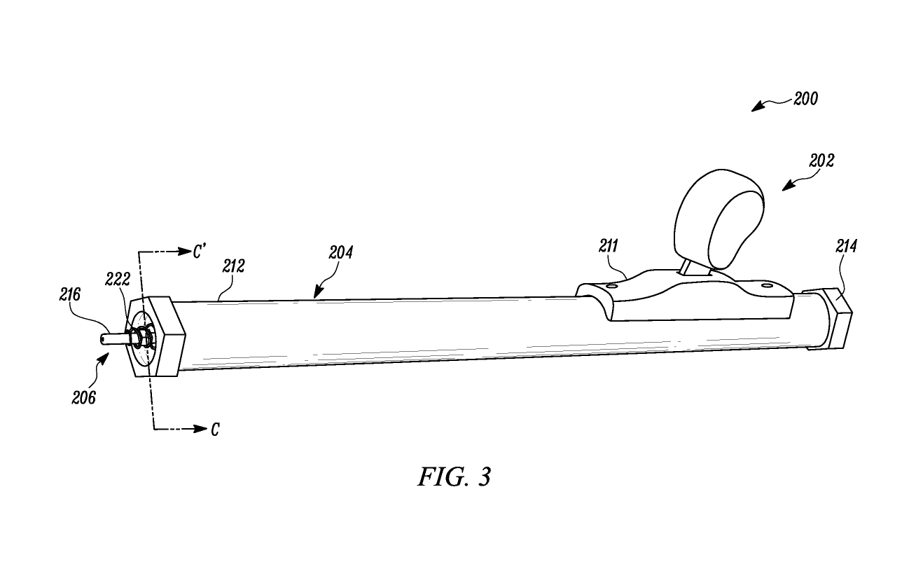

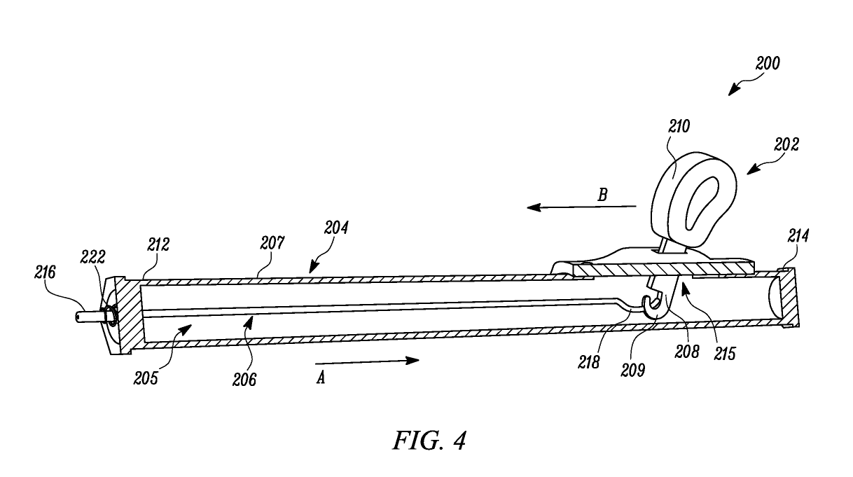

FIG. 3 illustrates a perspective view of a latch operating mechanism 200 for the cabin door 110, according to an embodiment of the present disclosure. Further referring to FIG. 4, a sectional view of the latch operating mechanism 200 is illustrated taken along section line C-C′ of FIG. 3, according to an embodiment of the present disclosure. As shown in FIGS. 3 and 4, the latch operating mechanism 200 may be provided on the cabin door 110, such that the latch operating mechanism 200 is associated with the latch 120.

The latch operating mechanism 200 includes a lever member 202, a tubular housing member 204 and an elongated member 206. The lever member 202 comprises a body portion 208 (shown in FIG. 4), and a handle portion 210 coupled to the body portion 208. The lever member 202 is coupled to the tubular housing member 204. Specifically, the body portion 208 of the lever member 202 is coupled to the tubular housing member 204. The handle portion 210 of the lever member 202 may extend radially outward from the tubular housing member 204. Accordingly, the handle portion 210 of the lever member 202 is positioned frontward relative to the latch 120 the operator's seat 106 where the operator can sit. The operator may hold the lever member 202 at the handle portion 210. Further, the handle portion 210 may also include a lining of soft material.

As shown in FIGS. 3 and 4, a hinge mechanism 211 may be provided on the tubular housing member 204. The hinge mechanism 211 may be bolted on an opening 215 formed in the wall of the tubular housing member 204. The hinge mechanism 211 facilitates the hinged connection of the body portion 208 of the lever member 202 with the tubular housing member 204. In an embodiment, the hinge mechanism 211 may include a bolt (not illustrated) extending through the body portion 208 of the lever member 202, such that the lever member 202 may hingedly move with respect to the tubular housing member 204. Alternatively, the hinge mechanism 211 may include a means to form a pin joint or a ball joint between the body portion 208 of the lever member 202 and the tubular housing member 204, allowing only one degree of freedom (hinged movement) to the lever member 202 with respect to the tubular housing member 204. Because of the hinged connection, the lever member 202 may be moved with respect to the tubular housing member 204 between the first and second longitudinal directions A and B, upon application of force. For instance, the lever member 202 may be moved in a direction indicated by line B (a rearward direction relative to the cabin 100) (shown in FIG. 4).

As best shown in FIG. 4, the tubular housing member 204 may have an elongated tubular shape, having an axially extending cavity 205. An end portion 212 of the tubular housing member 204 may be coupled to the latch 120. An opposite end portion 214 of the tubular housing member 204 may be coupled to the door frame 112. It may herein be noted that although in the present disclosure, the tubular housing member 204 is disclosed to have an elongated tubular shape defined by a set of sidewalls 207; the tubular housing member 204 may have any other shape such as an elongated channel section, without deviating from the spirit of the present disclosure.

Within the axially extending cavity 205 of the tubular housing member 204, the elongated member 206 is provided. The elongated member 206 is movable between an extended position for allowing the latch 120 to move to its latched position, and a retracted position for allowing the latch 120 to move to its unlatched position. The elongated member 206 includes a first end portion 218 and a second end portion 216 opposite to the first end portion 218. The first end portion 218 of the elongated member 206 may be coupled to the lever member 202. Specifically, the first end portion 218 of the elongated member 206 may be coupled to an end portion 209 of the body portion 208 of the lever member 202. In an embodiment of the present disclosure, the first end portion 218 of the elongated member 206 may be inserted through a hole on the end portion 209 of the body portion 208 of the lever member 202, such that a hinged movement between the lever member 202 and the elongated member 206 is allowed. Alternatively, a pin joint may be formed between the first end portion 218 of the elongated member 206 and the end portion 209 of the body portion 208 of the lever member 202, by a suitable means e.g. a bolt, allowing only one degree of freedom (hinged movement) between the lever member 202 and the elongated member 206.

The second end portion 216 of the elongated member 206 may be coupled to the latch 120. The latch 120 provided on the cabin door 110 includes a member (not illustrated) in engagement with the frame 102, in a latched position/state of the latch 120. The latch 120 further includes an actuating spring 220 (see FIG. 2). The actuating spring 220 is coupled with the member, such that when the actuating spring 220 is actuated, the member of the latch 120 the frame 102, to disengage it from the frame 102, thereby unlocking the latch 120 to its unlatched position. The second end portion 216 of the elongated member 206 may be coupled to the actuating spring 220 of the latch 120. In its extended position, the elongated member 206 is an axial distance away from the end portion 212 that greater than the distance when the elongated member 206 is at its retracted position. In its extended position, the elongated member 206 actuates the actuating spring 220.

The elongated member 206 is adapted to move laterally within the tubular housing member 204 in the first longitudinal direction (indicated by line A) and the second longitudinal direction (indicated by line B). A predetermined movement of the lever member 202 moves the elongated member 206 laterally. Therefore, when the lever member 202 is moved in the second longitudinal direction B, the elongated member 206 may move laterally within the tubular housing member 204 in the first longitudinal direction A. The movement of the elongated member 206 in the first direction A is configured to move the latch 120 of the cabin door 110 in an unlocked position, by moving the actuating spring 220 of the latch 120. Specifically, in its extended position (i.e. after movement of the elongated member 206 in the first direction A) the elongated member 206 pulls and moves the actuating spring 220 in the along the elongated member 206 in the first direction A. In this moved position, the actuating spring 220 moves a member of the latch 120 to disengage from the frame 102. In other words, in this moved position, the actuating spring 220 moves the latch 120 of the cabin door 110 in an unlocked position.

Further a biasing member 222 is provided on the second end portion 216 of the elongated member 206. The biasing member 222 is configured to bias the elongated member 206 to its extended position and thus thereby biasing the latch 120 to its latched position. In an embodiment, the biasing member 222 may be in the shape of a conical coil spring having a first end and an opposite end. The first end of the biasing member 222 may be connected to the second end portion 216 of the elongated member 206. The second end of the biasing member 222 may be connected to the tubular housing member 204. Alternatively, the second end of the biasing member 222 may be connected to a plate on the tubular housing member 204. In alternative embodiments, the biasing member 222 may have any other shape. The biasing member 222 may be adapted to apply a biasing force on the elongated member 206 against a lateral movement of the elongated member 206. Thus, for the movement of the lever member 202 in the second longitudinal direction, a force opposite to and greater than the biasing force of the biasing member 222 is to be applied would allow movement of the elongated member 206 away from its extended position to its retracted position. Likewise, the elongated member 206, upon its lateral movement because of the removal of force on the lever member 202, may return to its extended position.

### INDUSTRIAL APPLICABILITY

The present disclosure relates to the mechanism 200 for operating a latch 120 of a cabin door 110. The present disclosure also relates to a method 500 for operating the latch 120 of the cabin door 110.

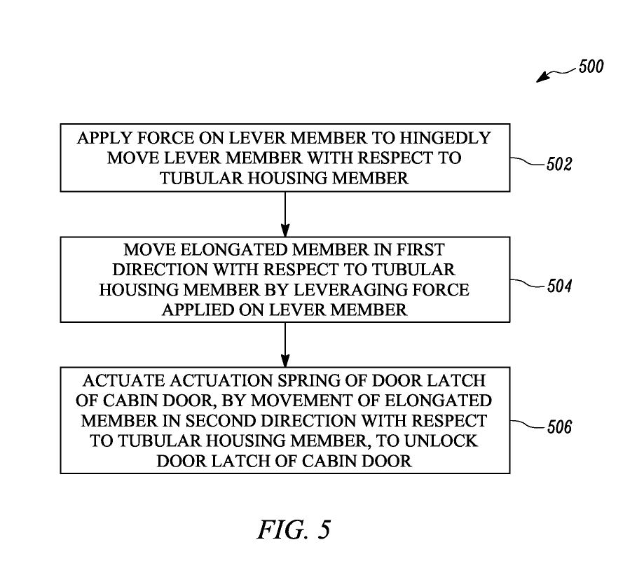

FIG. 5 illustrates a flowchart of the method 500 for operating the latch 120 of the cabin door 110, according to an embodiment of the present disclosure. At step 502, a force may be applied on the lever member 202. The force applied on the lever member 202 may be in a second longitudinal direction B, which may move the lever member 202 with respect to the tubular housing member 204 in the second direction B. As per the present embodiment the force may be applied by the operator, however in alternative embodiment an auxiliary power means may be provided for applying force to the lever member 202.

At step 504, the elongated member 206 moves in the first longitudinal direction A with respect to the tubular housing member 204 away from its extended position to a retracted position by a leveraging force applied on the lever member 202. The second end portion 216 of the elongated member 206 may be coupled to the actuating spring 220 of the latch 120. Therefore, at step 506, the movement of the elongated member 206 in the first longitudinal direction A with respect to the tubular housing member 204 to its retracted position may allow for the actuation of the actuating spring 220 of the latch 120 of the cabin door 110, to unlatch the latch 120 of the cabin door 110. Further at step 508, the biasing force is constantly applied on the elongated member 206 by the biasing member 222 to resist a movement of the elongated member 206. Further the biasing force on the elongated member 206 by the biasing member 222 may bring the elongated member 206 to its extended position once the operators force on the lever member 202 is removed.

With the present disclosure, the mechanism 200 and the method 500 allow the operator to conveniently take egress from the operator's cabin 100. As per the present disclosure mechanical advantage from linkages between the lever member 202 and the elongated member 206 reduces the overall effort required. Accordingly, the lever height or distance that it radially extends away from the hinge point in comparison with the distance between the coupling of the lever end portion and end portion of the elongated member 206 within the housing can be adjusted for improved mechanical advantage. Thus, the present disclosure and offers a technique that allows the operator to conveniently open the latch, without having to apply a considerable manual force. Therefore, the present disclosure offers the mechanism 200 that is effective, easy to use, economical, and time-saving. Furthermore, the housing may provide protection to the elongated member 206 and lever end portion from environment of the cab that can be often dusty and dirty, which can affect the performance of the door lever latch.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A latch operating mechanism for a cabin door, the latch operating mechanism comprising:
a lever member;
a tubular housing member coupled to the lever member and having an axially extending cavity, the tubular housing member adapted to be coupled to the cabin door, the tubular housing member having an opening formed therein through which the lever member is disposed, wherein the lever member is hingedly coupled to the tubular housing member along a hinge axis and is extended outwardly from the cavity of the tubular housing member; and
an elongated member positioned substantially within the axially extending cavity of the tubular housing member, the elongated member being coupled to the lever member and a latch of the cabin door, the elongated member being axially movable between an extended position and a retracted position, and being biased in its extended position,
wherein a predetermined movement of the lever member in a second direction moves the elongated member in a first direction away from its extended position, to unlock the latch of the cabin door.

2. The latch operating mechanism of claim 1, wherein the lever member comprises:
a body portion hingedly coupled to the tubular housing member; and
a handle portion adjacent to the body portion, the handle portion extending outwardly from the tubular housing member.

3. The latch operating mechanism of claim 1, wherein the elongated member comprises a first end portion hingedly coupled to the lever member and a second end portion coupled to an actuating spring of the latch of the cabin door.

4. The latch operating mechanism of claim 3, wherein the lever member is adapted to be hingedly moved in a second direction to move the elongated member in the first direction.

5. The latch operating mechanism of claim 4, wherein the movement of the elongated member in the first direction actuates the actuating spring of the latch to unlock the latch of the cabin door.

6. The latch operating mechanism of claim 3 comprising a biasing member coupled to the second end portion of the elongated member.

7. The latch operating mechanism of claim 6, wherein the biasing member adapted to apply a biasing force on the elongated member against a lateral movement of the elongated member.

8. The latch operating mechanism of claim 6, wherein the biasing member is a conical coil spring.

9. The latch operating mechanism of claim 1, wherein the tubular housing member includes a set of side walls defining the cavity.

10. The latch operating mechanism of claim 1, wherein the tubular housing member includes a hinge mechanism for hingedly connecting the lever member therewith.

11. A method of operating a latch of a cabin door, the method comprising:
applying a force on a lever member to hingedly move the lever member with respect to a tubular housing member;
moving an elongated member in a first direction with respect to the tubular housing member by a leveraging force applied on the lever member; and
actuating an actuating spring of the latch of the cabin door, by the movement of the elongated member in the first direction with respect to the tubular housing member, to unlock the latch of the cabin door.

12. The method of claim 11 further comprising applying a biasing force on the elongated member through a biasing member to resist a movement of the elongated member.

13. A machine comprising:
a frame;
a plurality of panel members coupled to the frame;
a cabin door coupled to the frame to enable egress and ingress in the cab;
a latch mounted on the cabin door;
a latch operating mechanism provided on the cabin door, the latch operating mechanism including:
a lever member;
a tubular housing member coupled to the lever member and having an axially extending cavity, the tubular housing member adapted to be coupled to the cabin door, the tubular housing member having an opening formed therein through which the lever member is disposed, wherein the lever member is hingedly coupled to the tubular housing member along a hinge axis and is extended outwardly from the cavity of the tubular housing member; and
an elongated member positioned substantially within the axially extending cavity of the tubular housing member, the elongated member being coupled to the lever member and a latch of the cabin door, the elongated member being axially movable between an extended position and a retracted position, and being biased in its extended position,
wherein a predetermined movement of the lever member in a second direction moves the elongated member in a first direction away from its extended position, to unlock the latch of the cabin door.

14. The cabin of claim 13, wherein the lever member comprises:
a body portion hingedly coupled to the tubular housing member; and
a handle portion adjacent to the body portion, the handle portion extending outwardly from the tubular housing member.

15. The cabin of claim 14, wherein the elongated member comprises a first end portion hingedly coupled to the lever member and a second end portion coupled to an actuating spring of the latch of the cabin door.

16. The cabin of claim 15, wherein the lever member is adapted to be hingedly moved in a second direction to move the elongated member in the first direction.

17. The cabin of claim 16, wherein the movement of the elongated member in the first direction actuates the actuating spring of the latch to unlock the latch.

18. The cabin of claim 13 further comprising a biasing member coupled to the second end portion of the elongated member, wherein the biasing member adapted to apply a biasing force on the elongated member against a lateral movement of the elongated member.

19. The cabin of claim 13, wherein the tubular housing member includes a set of side walls defining the cavity.

20. The cabin of claim 19, wherein the tubular housing member includes a hinge mechanism for hingedly connecting the lever member therewith.
